(19) United States
(12) Patent Application Publication
(10) Pub. No.: US 2012/0177825 A1
(43) Pub. Date: Jul. 12, 2012

(54) METHOD OF COATING A FABRIC USING A BLADE-COATING DEVICE

(76) Inventor: Kwang-Huo LIN, Taichung County (TW)

(21) Appl. No.: 13/005,208

(22) Filed: Jan. 12, 2011

(51) Int. Cl. B05D 3/00

(52) U.S. Cl. 427/299

(57) ABSTRACT

A method of coating a fabric includes advancing the fabric to a cutting device; cutting and trimming two opposite edges of the fabric that are hairy and that extend along an advancing direction of the fabric by using the cutting device such that hairy parts are removed from the opposite edges; and subsequently advancing the fabric to a blade-coating device, and spreading a coating material on a surface of the fabric using a coating blade of the blade-coating device. Since the hairy parts are removed, interference between the coating blade and the fabric can be avoided.

### BACKGROUND OF THE INVENTION

1. Field of the Invention

The invention relates to a method of coating a fabric, and more particularly to a method of coating a fabric using a blade-coating technique.

2. Description of the Related Art

Fabric coatings have existed in various types and are designed to provide fabrics with functional properties, such as aging resistance, chemical resistance, wear resistance, tear resistance, water resistance, fire-retarding, sun-shading, etc. Blade coating is one of the commonly used coating processes for applying the fabric coatings to fabrics, and are advantageous for high speed production and for coating large width fabrics.

Referring to FIGS. 1 and 2, a blade-coating process is used to apply a coating or functional layer 12 on a fabric 11. The fabric 11 is advanced to a coating supply 22 and a coating blade 23 through a series of rollers 21. The coating supply 22 delivered a coating material onto the surface of the fabric 11, and the coating blade 23 serves to spread evenly the coating material evenly on the fabric 11.

However, since the fabric 11 has two opposite edges 111 that are hairy and that have multiple thread ends 112 that gather together and entangle each other, the surface of the fabric 11 is uneven and untidy at the edges 111. When the fabric 11 is advanced through the coating blade 23, the hairy edges 111 tend to interfere with the coating blade 23. In some cases, the coating blade 23 may hook onto the edges 111, rupturing the fabric 11 and gathering the thread ends 112 near the coating blade 23. Therefore, the coating blade 23 is unable to uniformly spread the coating material onto the fabric 11. In order to cope with the problem of interference between the coating blade 23 and the fabric 11, the coating blade 23 is usually spaced far from the surface of the fabric 11 with a large spacing, which results in an increased thickness of the coating layer 12 and increased consumption of the coating material.

### SUMMARY OF THE INVENTION

A main object of the present invention is to provide a method of coating a fabric, which can overcome the problem of interference between a fabric and a coating blade.

Accordingly, the present invention provides a method of coating a fabric which comprises: advancing the fabric to a cutting device; cutting and trimming two opposite edges of the fabric that are hairy and that extend along an advancing direction of the fabric by using the cutting device such that hairy parts are removed from the opposite edges; and advancing the fabric to a blade-coating device, and spreading a coating material to a surface of the fabric using a coating blade of the blade-coating device after cutting the edges of the fabric.

### BRIEF DESCRIPTION OF THE DRAWINGS

Other features and advantages of the present invention will become apparent in the following detailed description of the preferred embodiment with reference to the accompanying drawings, of which:

FIG. 1 shows a fabric having two opposite hairy edges;

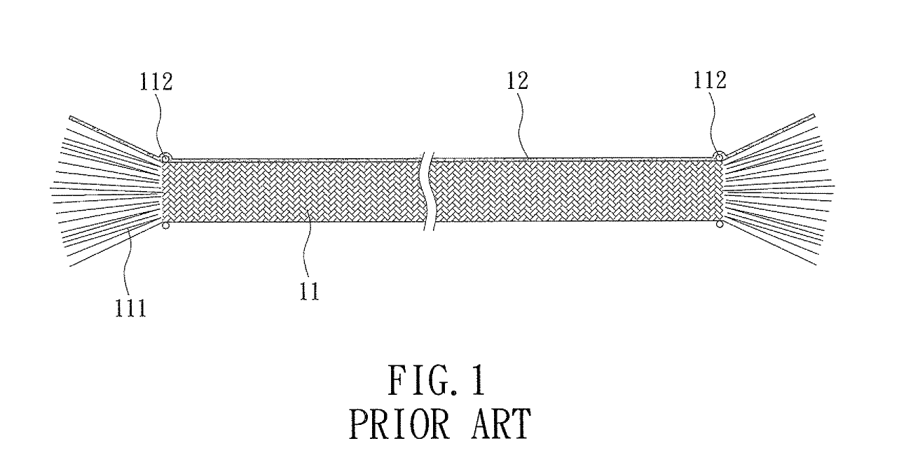

FIG. 2 shows a conventional blade coating process for coating the fabric of FIG. 2;

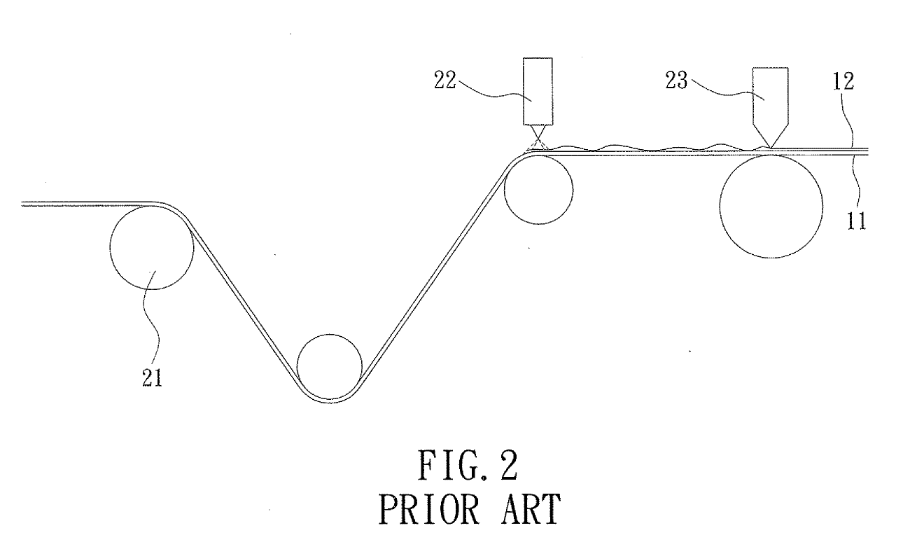

FIG. 3 is a schematic view illustrating a process of coating a fabric according to a preferred embodiment of the present invention;

FIG. 4 illustrates a cutting device used to cut and trim hairy edges of the fabric of FIG. 3; and

FIG. 5 is a flow diagram illustrating the process of FIG. 3.

### DETAILED DESCRIPTION OF THE PREFERRED EMBODIMENTS

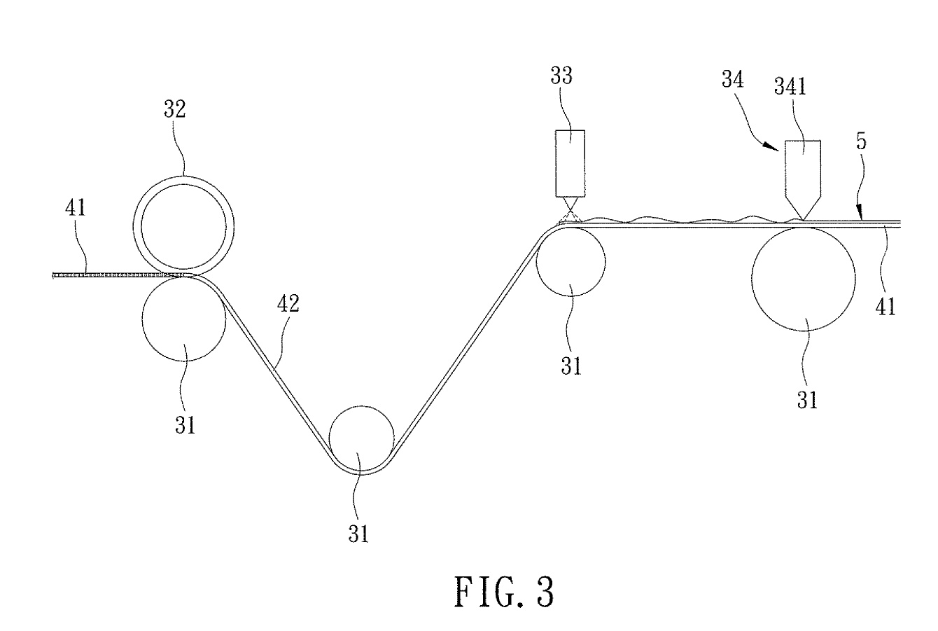

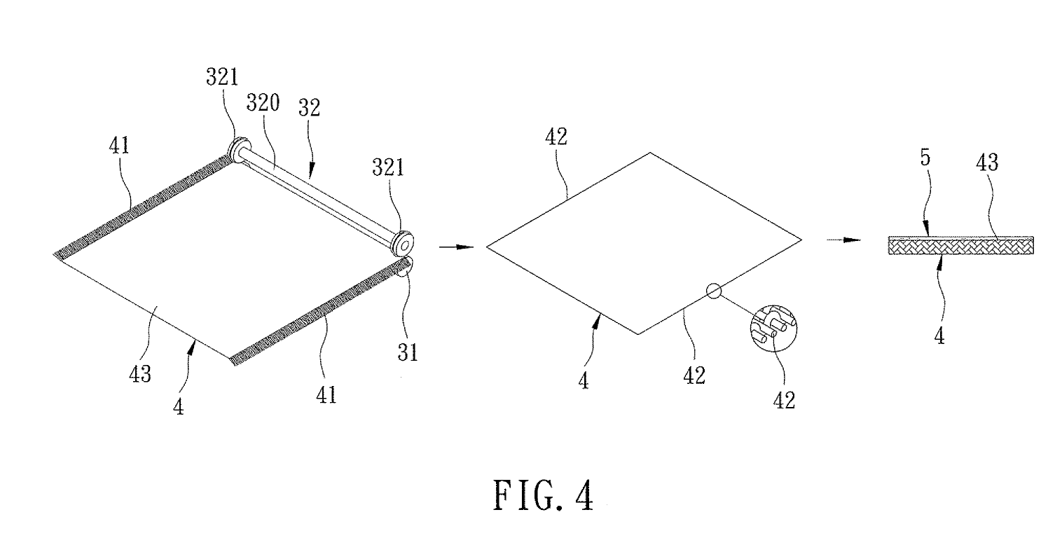

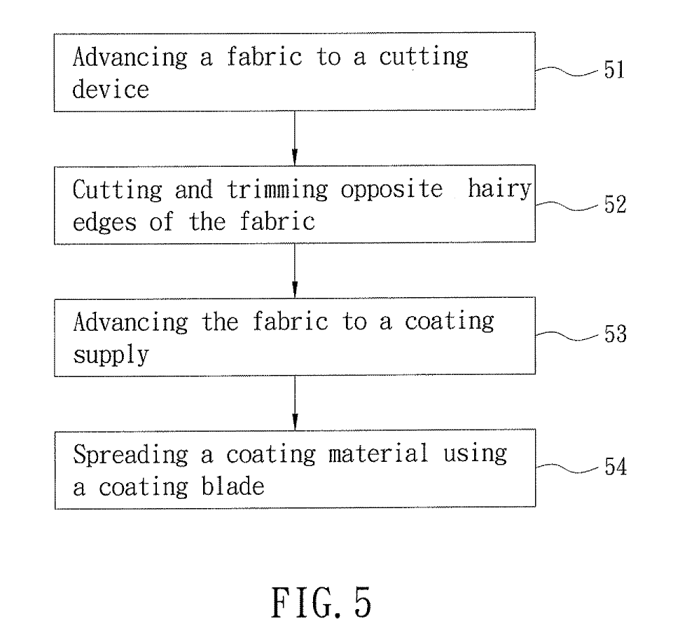

Referring to FIG. 5 in combination with FIGS. 3 and 4, a method of coating a fabric according to a preferred embodiment of the present invention includes steps 51 to 54.

In step 51, a fabric 4 is advanced through a set of rollers 31 to a cutting device 32. The fabric 4 has two opposite edges 42 that are hairy and that extend along an advancing direction of the fabric 4.

In step 52, the opposite edges 41 of the fabric 4 are cut and trimmed by the cutting device 32. The cutting device 32 has a shaft 320 that is transverse to the advancing direction of the fabric, and two circular cutters 321 mounted respectively to two opposite ends of the shaft 320. After the opposite edges 41 of the fabric 4 are cut, the hairy parts of the edges 41 are removed so that the hairy edges 41 become trimmed edges 42.

Preferably, the circular cutters 321 are heated to fuse the edges 41 of the fabric. Thus, the edges 41 of the fabric 4 are cut and fused simultaneously and are formed into fused hems, respectively. Alternatively, the fusing of the edges 41 of the fabric may be carried out using fusing blades after cutting the edges 41 using the cutting device 32.

In step 53, the fabric 4 is advanced to a coating supply 33 downstream of the cutting device 32. The coating supply 33 sprays a coating material 5 onto a surface 43 of the fabric 4. The coating material 5 may be an adhesive, an air-permeable waterproof coating, or a surface treatment coating.

In step 54, the fabric 4 is advanced to a blade-coating device 34 has a coating blade 341 downstream of the coating supply 33. The coating blade 341 spreads evenly the coating material 5 on the surface 43 of the fabric 4.

The coating material 5 may be applied to the surface 43 of the fabric 4 in multiple layers as desired. In addition, for mass production, the fabric 4 may be advanced continuously and may be lengthened by joining together multiple sheets of the fabric 4, followed by calendaring the multiple sheets of the fabric 4.

Because the fabric 4 is cut and trimmed at two opposite edges 111 thereof before being coated with the coating material 5, the opposite edges 111 have no protruding surfaces that will interfere with the coating blade 341. Therefore, the coating blade 341 and the fabric 4 may be spaced apart from each other with a minimum spacing that permits reduction of the thickness of the coating material 5 formed on the fabric 4 and consumption of the coating material 5 supplied to the fabric 4.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of coating a fabric, comprising:
(a) advancing the fabric to a cutting device;
(b) cutting and trimming two opposite edges of the fabric that are hairy and that extend along an advancing direction of the fabric by using the cutting device such that hairy parts are removed from the opposite edges; and
(c) advancing the fabric to a blade-coating device, and spreading a coating material on the surface of the fabric using a coating blade of the blade-coating device after cutting the edges of the fabric.

2. The method of claim 1, wherein the coating material is selected from a group consisting of an adhesive, a water-proof coating, and a surface treatment coating.

3. The method of claim 1, wherein the cutting device is heated so that the opposite edges of the fabric are fused and cut simultaneously by the cutting device.

4. The method of claim 1, wherein the cutting device includes a shaft that is transverse to the advancing direction of the fabric, and two circular cutters mounted respectively to two opposite ends of the shaft to cut the opposite edges of the fabric.
